(19) United States
(12) Patent Application Publication
(10) Pub. No.: US 2017/0232589 A1
(43) Pub. Date: Aug. 17, 2017

(54) Optimized Setting Method for Expansion Anchors

(71) Applicant: Hilti Aktiengesellschaft, Schaan (LI)

(72) Inventor: Hans-Dieter GAUL, Augsburg (DE)

(73) Assignee: Hilti Aktiengesellschaft, Schaan (LI)

(21) Appl. No.: 15/503,264

(22) PCT Filed: Aug. 11, 2015
(86) PCT No.: PCT/EP2015/068416

§ 371 Date: Feb. 10, 2017

(30) Foreign Application Priority Data
Aug. 12, 2014 (EP) 14180630.7

(51) Int. Cl. B25B 21/02; B25B 23/147; B25B 31/00

(52) U.S. Cl. CPC B25B 21/02; B25B 31/00; B25B 23/1475

(57) ABSTRACT

A method for setting an expansion anchor by a power tool, and a power tool that performs the method, is disclosed. In an embodiment, the method includes applying rotational impacts to the expansion anchor in accordance with a first rotational speed until a rotational angle per time interval of an output shaft of the power tool falls below a predetermined threshold value and applying rotational impacts to the expansion anchor in accordance with a reduced second rotational speed for a predetermined duration.

This application claims the priority of International Application No. PCT/EP2015/068416, filed Aug. 11, 2015, and European Patent Document 14180630.7, filed Aug. 12, 2014, the disclosures of which are expressly incorporated by reference herein.

### BACKGROUND AND SUMMARY OF THE INVENTION

The present invention relates to a method for a setting an expansion anchor by means of a power tool, in particular an impact screwdriver. The present invention also relates to a power tool, in particular an impact screwdriver, for carrying out this method, comprising an input device for capturing a type of an expansion anchor or a tightening torque for the expansion anchor, an impact unit for producing rotational impacts that can be transferred from and to the expansion anchor, a device for sensing a rotational angle of an output shaft of the power tool and a control device.

Expansion anchors are inserted into a pre-drilled hole and then generally speaking tightened in the hole by means of a torque wrench. The use of a torque wrench has proven to be necessary, because a user is not able to see whether the expansion anchor inserted into the hole has expanded properly, i.e., is set properly. In this connection, problems arise both in terms of not enough expansion and thus with lower loading capacity of the anchoring in the substrate as well as too much expansion, because of a possible fatigue of the expansion anchor. The manufacturers of the expansion anchor correspondingly indicate an associated tightening torque, which is supposed to be adjusted on the torque wrench for setting.

A setting method for an expansion anchor and an impact screwdriver for setting an expansion anchor in accordance with the prior art is disclosed for example in German patent application DE 10 2011 005 079 A1. This prior art document describes a setting method for an expansion anchor by means of an impact screwdriver, in which rotational impacts are repeatedly applied to the expansion anchor. A repetition rate of the rotational impacts is adjusted in accordance with a predefined tightening torque for expanding an expansion sleeve of the expansion anchor. The impact screwdriver adjusts the application of rotational impacts, when a captured average rotational speed falls below a threshold value on an expansion anchor nut.

It was established in test series that the relaxation behavior of an expansion anchor was dependent on the setting speed with which the expansion anchor is positioned in a material (e.g., mineral substrate). In this case, relaxation describes the gradual loss of prestressing force of the expansion anchor set in a material due to setting effects.

In the case of expansion anchors which are set with a high tightening speed, a very major drop in the prestressing force of the expansion anchor set in a material was observed during the first minutes after concluding the setting process. In the case of a conventional setting method (i.e., manually setting an expansion anchor in a material) with a torque wrench, this loss in the prestressing force is less pronounced. An increased loss in prestressing force diminishes the load values that can be achieved with the expansion anchor and thereby restricts the application range of the expansion anchor.

The loss in prestressing force is presumably caused by a very high speed of the setting process. In the case of hand tightening (i.e., when manually setting an expansion anchor in a material), a torque is normally applied in several intervals over a time period of approx. 20 sec. During the breaks between these intervals, in which the restoring movement is executed with the torque wrench, local stress peaks in the material (e.g., concrete) can already be dissipated. With a next restoring movement or with another stroke by the torque wrench, the resulting loss in prestressing force is again compensated.

When setting using an impact screwdriver, the entire setting process of the expansion anchor is concluded within approx. 2 sec. As a result, there is not enough time to dissipate the stress peaks between the setting intervals. For this reason, the setting process does not take place until the actual setting process has been concluded.

Therefore, the object of the present invention is to solve the problem described in the foregoing and in particular make available a method for setting an expansion anchor by means of a power tool, in particular an impact screwdriver, as well as a power tool, in particular an impact screwdriver, for carrying out this method. The setting process of an expansion anchor is optimized by the method and the power tool for carrying out the method such that the expansion anchor can be subjected to a highest possible tensile force load.

For this purpose, a method is made available for setting an expansion anchor by means of a power tool, in particular an impact screwdriver.

The method is characterized according to the invention by the steps:
Applying rotational impacts to an expansion anchor via the power tool for expanding an expansion sleeve of the expansion anchor in accordance with a first rotational speed produced in the power tool until a rotational angle per time interval of an output shaft of the power tool falls below a predetermined threshold value; and
Applying rotational impacts to the expansion anchor via the power tool for expanding an expansion sleeve of the expansion anchor in accordance with a second rotational speed that is reduced as compared to the first rotational speed for a predetermined duration.

By applying further rotational impacts on the already set expansion anchor with a reduced rotational speed, a retightening can be produced on the expansion anchor, whereby the setting effects can be compensated without the prestressing force having to be increased further in the expansion anchor.

In addition, a power tool, in particular an impact screwdriver, is made available for carrying out this method, comprising an input device for capturing a type of an expansion anchor or a tightening torque for the expansion anchor, an impact unit for producing rotational impacts that can be transferred from and to the expansion anchor, a device for sensing a rotational angle per time interval of an output shaft of the power tool and a control device.

According to the invention, the power tool is characterized in that the control device is designed to set a first rotational speed produced in the power tool, whereby rotational impacts dependent on the first rotational speed can be applied to the expansion anchor for expanding an expansion sleeve of the expansion anchor until a rotational angle per time interval of the output shaft of the power tool falls below a predetermined threshold value and to set a second rotational speed produced in the power tool that is reduced as compared to the first rotational speed, wherein rotational impacts dependent on the second rotational speed can be applied for a predetermined duration to the expansion anchor in order to expand the expansion sleeve of the expansion anchor.

A retightening on the expansion anchor can hereby be produced, whereby the setting effects can be compensated without the prestressing force having to be increased further in the expansion anchor.

Additional advantages are yielded from the following description of the figures. Different exemplary embodiments of the present invention are depicted in the figures. The figures, the descriptions and the claims contain numerous features in combination. A person skilled in the art will also expediently consider the features individually and combine them into meaningful additional combinations.

### BRIEF DESCRIPTION OF THE DRAWINGS

FIG. 1 shows an expansion anchor in a borehole, and

FIG. 2 shows a power tool in accordance with the invention in the form of an impact screwdriver and an expansion anchor in a borehole.

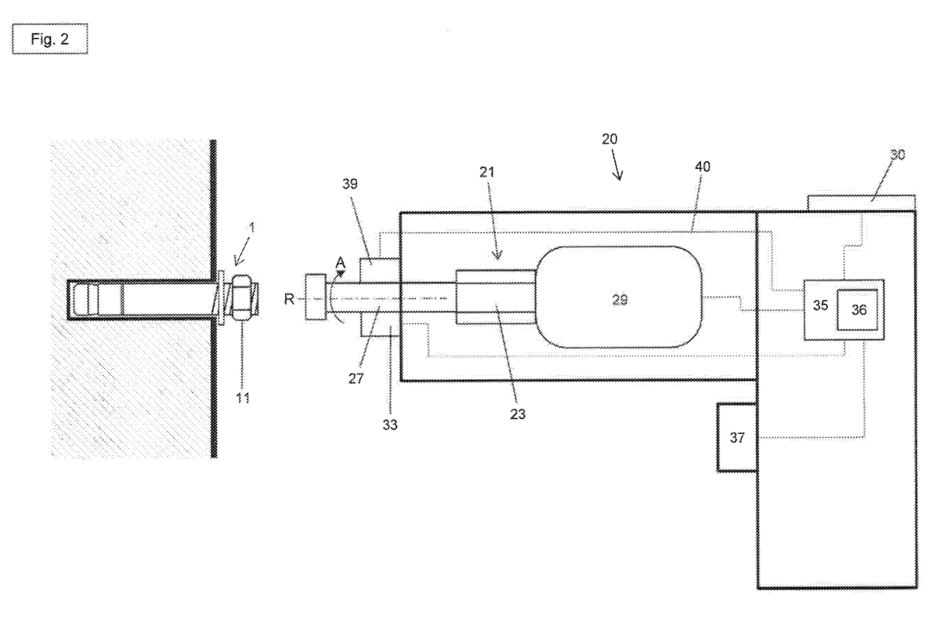

### DETAILED DESCRIPTION OF THE DRAWINGS

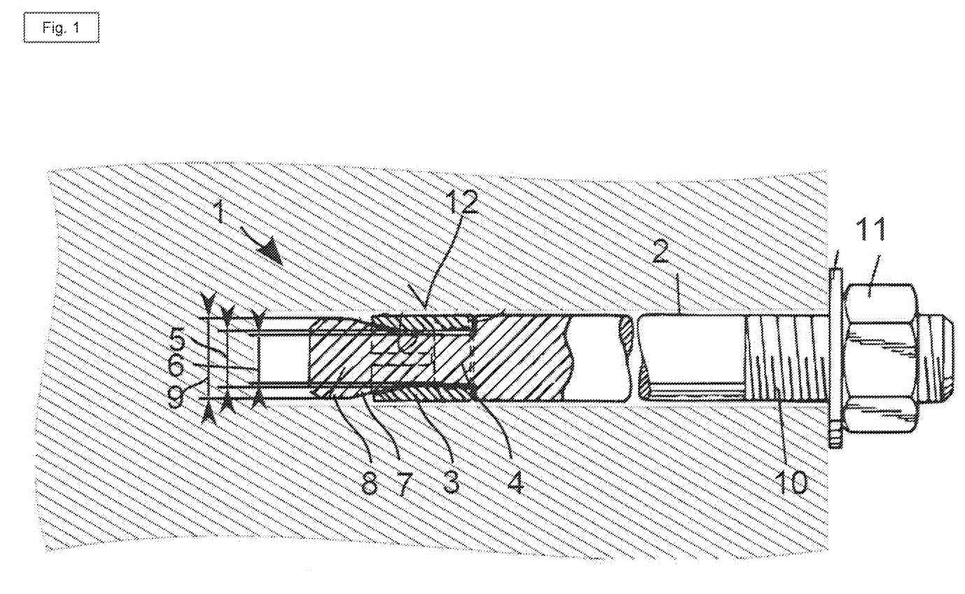

FIG. 1 shows an exemplary expansion anchor 1 consisting of a connecting rod 2 and an expansion sleeve 3. The expansion sleeve 3 circumferentially surrounds a cylindrical section 4 of the connecting rod 2. An outside diameter 5 of the cylindrical section 4 is preferably somewhat smaller than an inside diameter 6 of the expansion sleeve 3, whereby the connecting rod 2 is axially movable with respect to the expansion sleeve 3. The cylindrical section 4 merges into a conical section 7, which forms an expansion body 8 for expanding the expansion sleeve 3. The largest diameter of the conical section 7 is larger than the inside diameter 6 of the expansion sleeve 3 and preferably smaller than an outside diameter 9 of the expansion sleeve 3. Provided on the connecting rod 2 is a thread 10, via which a tensile force can be initiated. In the case of the exemplary expansion anchor 1, the thread 10 is used at the same time as a fixation for loads. During an installation, the expansion anchor 1 with the expansion body 8 is inserted in advance in a borehole with a diameter that is somewhat smaller than the outside diameter of the unexpanded expansion sleeve 3. A nut 11 is screwed onto the thread 10 and tightened so long until the connecting rod 2 together with the expansion body 8 is drawn into the expansion sleeve 3. In the process, the expansion sleeve 3 clamps on a wall 12 of the borehole. The expansion anchor 1 is properly set when the expansion sleeve 3 is radially expanded by a specific measure. A user is able to identify this when the nut 11 no longer rotates in the case of a specified tightening torque.

Other expansion anchors (not shown) can be for example a bolt with a counter thread, which engages the thread 10 of the connecting rod 2. During installation, the user attaches an assembly tool for screws and nuts to the bolt and in this manner draws the connecting rod 2 with the expansion body 8 into expansion sleeve 3.

The exemplary expansion anchors 1 can be set by means of an adapted impact screwdriver 20. To this end, the impact screwdriver 20 is connected to the expansion anchor 1 in such a way that the tightening torque that can be produced in the impact screwdriver 20 is transferred correspondingly to the expansion anchor 1 and in particular to the nut 11.

The impact screwdriver 20 has an impact unit 21, which periodically produces rotational impacts in rotational direction A. A hammer (not shown) is mounted on a drive shaft 23 by means of a helical slider (not shown). A spring (not shown) presses the hammer along the output shaft 23 in the direction of an anvil (not shown). The anvil is rigidly connected to an output shaft 27. The drive shaft 23 and the output shaft 27 are rotatable relative to each other. The hammer and the anvil have projecting claws (not shown) along the drive shaft 23, via which claws the hammer is able to transfer a torque to the anvil. An electric motor 29 drives the drive shaft 23 via a gear mechanism (not shown). A cycle of a rotational impact essentially has the following phases. The claws of the hammer abut against the anvil. The rotating drive shaft 23 pulls the hammer away from the anvil due to the slider against the force of the spring until the claws are disengaged from the anvil. Driven by the spring, the hammer moves in the direction of the anvil and is thereby set into a rotational motion by the slider. The claws finally strike tangentially against the anvil.

One embodiment of the impact screwdriver 20 has an input device 30, by means of which a user can input the special tightening torque of the expansion anchor 1. The input device 30 includes for example a button (not shown), a keyboard (not shown), a control panel (not shown) and/or a display element (not shown). Alternatively or additionally, an input device 30 can be provided via which the user can set a type as well as the associated tightening torque for an expansion anchor. For example, two buttons for selecting a type or a model of the expansion anchor and a size of the expansion anchor. The selected type of the expansion anchor as well as the associated tightening torque can be displayed for example in a display element that is designed as a display or via several LEDs.

A control unit 35 reads in the input tightening torque from the input device 30 or from the detection unit 33. The detection unit 33 can be realized in the form of a scanner, a sensing element, an input field or the like.

The control device 35 determines a first rotational speed for the drive shaft 23 based on the input tightening torque. For example, rotational speeds associated with different tightening torques are stored in a storage device 36. After a user activates the electric motor 29 by means of a button (not shown), the control device 35 checks whether a rotational speed was previously specified, in other words, for example, by specifying the expansion anchor type or the tightening torque. The control device 35 can prevent an activation of the motor 29 for example if a tightening torque was not selected as yet, but also prompt the user for an input. The control device 35 regulates the electric motor 29 in such a way that the drive shaft 23 rotates with the prescribed first rotational speed, The selected first rotational speed of the drive shaft 23 specifies the repetition rate of the rotational impacts. It was recognized that when lowering the rotational speed not just the frequency of the rotational impacts drops, which is irrelevant for setting the expansion anchor, but also that the torque applied with every rotational impact is reduced. A torque is allocated to each of the rotational speeds, namely with a large tolerance. In one embodiment, the impact screwdriver 20 begins to rotate the nut 11 with the maximum possible rotational speed of the impact screwdriver. After a time duration, which is preferably determined by the type of the expansion anchor 1 input, the impact screwdriver reduces the rotational speed to the rotational speed predetermined in accordance with the tightening torque. The tightening torque is a tightening torque predetermined for the expansion anchor that is respectively used.

Arranged on the output shaft 27 is a device 39 for sensing a rotational angle per time interval of an output shaft 27 around a rotational axis R. In the depicted embodiment, the device 39 for sensing a rotational angle per time interval of an output shaft 27 is realized by a rotational angle sensor. The rotational angle sensor 39 is used to sense the rotational angle per time interval of the output shaft 27 around the rotational axis R. The rotational angle sensor 39 can be designed thereby in the form of one or more magnetic field sensors, such as, for example, Hall sensors. The sensed rotational angle per time interval of the output shaft 27 around a rotational axis R is transmitted to the control device 35 via a connecting cable 40. The control device 35 compares the rotational angle per time interval of the output shaft 27 sensed by the rotational angle sensor 39 with the threshold values for the rotational angles per time interval of the output shaft 27 stored in the storage device 36. When the rotational angle per time interval of the output shaft 27 sensed by the rotational angle sensor 39 falls below a predetermined threshold value, this an indication that the expansion anchor can no longer continue to rotate with the rotational impacts being applied thereto or with the torque acting thereon from the impact screwdriver that is set to the first rotational speed and is properly set in the borehole. According to an embodiment that is not shown and not described further, a rotational angle sensor is not absolutely provided since the rotational angle per time interval can be determined indirectly with a corresponding device from the motor rotational angle.

Then the control device 35 adjusts the electric motor such that a second rotational speed is applied for the drive shaft 23. The second rotational speed is thereby less than the first rotational speed. The second or lower rotational speed produces rotational impacts with a correspondingly lower tightening torque, which is applied to the expansion anchor for a predetermined time duration t. A retightening can be produced on the expansion anchor, whereby the setting effects can be compensated without the prestressing force having to be increased further in the expansion anchor.

The setting process of the expansion anchor 1 is thereby optimized by the method according to the invention and the power tool 20 for carrying out this method such that the expansion anchor 1 in the borehole can be subjected to a highest possible tensile force load.

1.-2. (canceled)

3. A method for setting an expansion anchor by a power tool, comprising the steps of:
applying rotational impacts to the expansion anchor via the power tool and expanding an expansion sleeve of the expansion anchor in accordance with a first rotational speed produced in the power tool until a rotational angle per time interval of an output shaft of the power tool falls below a predetermined threshold value; and
applying rotational impacts to the expansion anchor via the power tool and expanding the expansion sleeve of the expansion anchor in accordance with a second rotational speed produced in the power tool that is reduced as compared to the first rotational speed for a predetermined duration.

4. The method according to claim 3, wherein the power tool is an impact screwdriver.

5. A power tool, comprising:
an input device for capturing a type of an expansion anchor or a tightening torque for the expansion anchor;
an impact unit for producing rotational impacts that are transferable to the expansion anchor;
a sensor for sensing a rotational angle per time interval of an output shaft of the power tool; and
a control device, wherein the control device is configured to set a first rotational speed produced in the power tool whereby rotational impacts dependent on the first rotational speed are applyable to the expansion anchor for expanding an expansion sleeve of the expansion anchor until a rotational angle per time interval of the output shaft of the power tool falls below a predetermined threshold value and configured to set a second rotational speed produced in the power tool that is reduced as compared to the first rotational speed, wherein rotational impacts dependent on the second rotational speed are applyable for a predetermined duration to the expansion anchor for expanding the expansion sleeve of the expansion anchor.

6. The power tool according to claim 5, wherein the power tool is an impact screwdriver.

7. A method for setting an expansion anchor by a power tool, comprising the steps of:
applying first rotational impacts to the expansion anchor via the power tool with a first rotational speed of the power tool; and
after the step of applying the first rotational impacts, applying second rotational impacts to the expansion anchor via the power tool with a second rotational speed of the power tool, wherein the second rotational speed is less than the first rotational speed.
